(19) United States
(12) Patent Application Publication
(10) Pub. No.: US 2007/0186118 A1
(43) Pub. Date: Aug. 9, 2007

(54) Content data processing device, recording/reproduction device, and recording/reproduction system

(76) Inventors: Kazuyo Azuma, Osaka (JP); Yusuke Yagi, Kyoto (JP)

Correspondence Address: MCDERMOTT WILL & EMERY LLP, 600 13TH STREET, NW, WASHINGTON, DC, 20005-3096, US

(21) Appl. No.: 11/628,938

(22) PCT Filed: Feb. 23, 2005
(86) PCT No.: PCT/JP05/02856

§ 371 Date: Dec. 8, 2006

(30) Foreign Application Priority Data
Jun. 9, 2004 (JP) 2004-171041

(51) Int. Cl. H04N 7/16; H04L 9/00; G06F 12/14; H04L 9/32; G06F 17/30; G06F 11/30; G06F 7/04; G06K 9/00; H03M 1/68; H04K 1/00

(52) U.S. Cl. 713/193; 380/44; 726/26

(57) ABSTRACT

In the case of the ordinary Move function, the original content is erased and when normal move cannot be performed, the content is lost. This problem can be solved without departing from the Move concept of copy once. Unique IDs are acquired from at least two recording device and a mutual ID having the unique ID and a mutual encryption key as elements is created. Here, it is assumed that when the mutual ID is copied together with the encrypted content to another recording device, the original mutual ID is deleted. In a recording device where the mutual ID and the encrypted content are both recorded, reproduction and decryption is enabled when one of the unique IDs in the mutual ID is matched with the unique ID of the recording device.

### TECHNICAL FIELD

The present invention relates to a content data processing device using a digital content distributed by broadcasting, and particularly relates to a technique of avoiding disadvantages due to movement of the content when a limit of copying is provided to the content in terms of copyright protection.

### BACKGROUND ART

In recent years, a recording device and a recording medium for digitally recording video, audio, and image has become widespread. Copy of digital data can be repeated many times, while maintaining image quality and sound quality, thereby involving a problem that an advantage of a copyrighter and a distributor is impaired. Therefore, various mechanisms for preventing illegal copying are introduced.

For example, in digital terrestrial broadcasting and BS digital broadcasting, a copy once function is used, whereby a broadcasted content can be recordable only once. In some cases, a copy once limited content is received from broadcasting and recorded in the recording device, then further by using a function called “Move”, the content is moved to other recording device. Here, the Move is the function to copy the content accumulated in a first recording device into a second recording device and thereafter completely delete the content of the first recording device.

Also, there is a content using system for solving a user request and the protection of a copyright in a well-balanced state by using a content ID and a network key shared in a network, thereby encrypting content key information (for example, see patent document 1).

Patent document 1: Japanese Patent Publication Laid Open NO. 2004-5526 (FIGS. 1 to 3 on pages 13 to 15)

### DISCLOSURE OF THE INVENTION

Problem to be Solved by the Invention

When the Move function is used, content data recorded in an original recording device and a recording medium is completely deleted. Therefore, when the content data cannot be normally moved, and when the recording device or the recording medium, wherein the content data is moved, is broken, an inconvenience sometimes occurs, such as losing the content data.

Also, when the Move is performed once in a state of an irreversible conversion such as a low data rate and a different compression system, the problem is also involved therein such as being unable to obtain an initial high quality again.

Also, when the Move is performed to one medium while the Move to various media is desired, the problem is also involved therein such as being unable to perform Move to other media.

In order to solve the above-described problems comprehensively, an object of the present invention is to provide a method and a system without departing from a Move concept such as a copy once.

Means for Solving the Problem

In order to solve the above-described problems, the present invention adopts several means as follows.

Unique IDs are acquired from two or more recording devices or recording media, an encryption key (referred to as a mutual encryption key hereafter) for encrypting the content from the acquired unique IDs is prepared, and a mutual ID, with the unique IDs and the mutual encryption key as elements, is prepared. The mutual ID functions to permit encrypted data to be reproduced, decrypted, and copied after collation between the mutual ID and the unique IDs.

The content recorded by a first recording device is reproduced, and the content re-encrypted by the mutual encryption key included in the mutual ID is recorded by a first device and a second device. The mutual ID is controlled so as to exist in only either one of the first device or the second device, thereby making it impossible to reproduce, decrypt, and copy the encrypted data without the mutual ID.

In addition, a “Move Back” is enabled, whereby the encrypted data can be reproduced by returning the mutual ID to the recording device or the recording medium wherein the encrypted content is in a reproduction disable state because the mutual ID is not recorded.

Further, the data rate and the compression system during Move can be arbitrarily set.

Further specific explanation will be given hereunder.

The content data processing device of the present invention is connected to a plurality of recording devices or recording media, comprising:
a unique ID reading means for reading at least two unique IDs from the plurality of recording devices or recording media;
a mutual ID creating means for creating the mutual encryption key from the aforementioned at least two unique IDs, creating the mutual ID, with the mutual encryption key and the aforementioned at least two unique IDs as elements, and recording the mutual ID in any one of the plurality of recording devices or recording media; and
an original data suppressing means for encrypting the data recorded in the recording device or the recording medium by using the mutual encryption key included in the mutual ID, recording the encrypted data in any one of the plurality of recording devices or recording media, and making the original data deleted or unreadable.

The content data processing device according to the above-described structure is provided, further comprising:
a reproduction suppressing means for determining whether or not read unique ID corresponds to either one of at least two unique IDs in the mutual ID when the unique ID reading means reads the unique ID from the recording device or the recording medium in which the mutual ID and the encrypted data are recorded, permitting the encrypted data to be reproduced when the read unique ID corresponds to either one of at least two unique IDs, and suppressing the reproduction of the encrypted data when the read unique ID corresponds to neither of them.

Further, the content data processing device according to the above-described structure is provided, comprising:
a decryption suppressing means for determining whether or not read unique ID corresponds to either one of at least two unique IDs in the mutual ID, when the unique ID reading means reads the unique ID from the recording device or the recording medium in which the mutual ID and the encrypted data are recorded, permitting the encrypted data to be decrypted when the read unique ID corresponds to either one of at least two unique IDs, thereby decrypting the encrypted data by using the mutual encryption key in the mutual ID and recording it in the recording device or the recording medium, then making the encrypted data and the mutual ID deleted or unreadable, and suppressing the decryption of the encrypted data when the read unique ID corresponds to neither of them.

Further, the content data processing device according to the above-described structure is provided, comprising:
a copy suppressing means for determining whether or not read unique ID corresponds to either one of at least two unique IDs in the mutual ID, when the unique ID reading means reads the unique ID from the recording device or the recording medium in which the mutual ID and the encrypted data are recorded, permitting the encrypted data to be copied to the recording device or the recording medium when the read unique ID corresponds to either one of at least two unique IDs, and suppressing the copy of the encrypted data to the recording device or the recording medium when the read unique ID corresponds to neither of them.

Further, any one of the above-described content data processing devices and a recording/reproduction device having a plurality of recording devices or recording media are also useful.

In addition, any one of the above-described content data processing devices and a recording/reproduction system, in which a plurality of devices having at least one recording device or recording medium are connected, are also useful.

### EFFECTS OF THE INVENTION

According to the present invention, the mutual ID is created, with the unique ID read from the recording device or the recording medium and the mutual encryption key created based on the unique ID as elements, the content is encrypted by the mutual encryption key, and reproducing, decrypting, and copying of the encrypted content are limited by performing authentication using the mutual ID. Thus, reliability of a Move function can be improved without departing from the Move concept of the copy once. In addition, backup of the content is realized by the reproduction of the encrypted content by the mutual ID and by using a method for limiting a decryption, and the content of high image quality can be restored before conversion even when the irreversible conversion, thereby inviting deterioration, is performed.

### BRIEF DESCRIPTION OF THE DRAWINGS

FIG. 1 is a block diagram showing a structure of an integrated recording/reproduction device (type 1) according to an embodiment 1 of the present invention, in which two or more of recording devices or recording media are incorporated.

FIG. 2 is a block diagram showing the structure of the integrated recording/reproduction device according to the embodiment 1 of the present invention.

FIG. 3 is a flowchart showing a Move function improved in reliability in the integrated recording/reproduction device according to the embodiment 1 of the present invention.

FIG. 4 is a view showing a structure of a mutual ID according to an embodiment of the present invention.

FIG. 5 is a view showing the structure of the mutual ID according to the embodiment of the present invention.

FIG. 6 is a view showing the structure of the mutual ID according to the embodiment of the present invention.

FIG. 7 is a flowchart showing a mutual ID creation procedure according to the embodiment of the present invention.

FIG. 8 is a flowchart showing a reproduction suppressing procedure according to the embodiment of the present invention.

FIG. 9 is a flowchart showing a decryption suppressing procedure according to the embodiment of the present invention.

FIG. 10 is a view of a case (type 2) of connecting two recording/reproduction devices incorporating one or more recording devices or recording media according to an embodiment 2 of the present invention.

FIG. 11 is a block diagram showing a structure of a case (type 2) of connecting two recording/reproduction devices incorporating one or more recording devices or recording media according to the embodiment 2 of the present invention.

FIG. 12 is a flowchart showing a Move function improved in reliability of the case (type 2) of connecting two recording/reproduction devices incorporating one or more recording devices or recording media according to the embodiment 2 of the present invention.

FIG. 13 is a flowchart showing a unique ID reading procedure of the case (type 2) of connecting two recording/reproduction devices incorporating one or more recording devices according to the embodiment 2 of the present invention.

FIG. 14 is a view of a network (type 3) of connecting two or more recording/reproduction devices incorporating one or more recording devices or recording media according to an embodiment 3 of the present invention.

FIG. 15 is a block diagram showing the structure of the network (type3) of connecting two or more recording/reproduction devices incorporating one or more recording devices or recording media according to an embodiment 3 of the present invention.

FIG. 16 is a flowchart showing the Move function improved in reliability in the network (type 3) of connecting two or more recording/reproduction devices incorporating one or more recording devices or recording media according to the embodiment 3 of the present invention.

FIG. 17 is a flowchart showing a Move Back function in an integrated recording/reproduction device according to an embodiment 4 of the present invention.

FIG. 18 is a flowchart showing an irreversible conversion Move function in the integrated recording/reproduction device according to an embodiment 5 of the present invention.

FIG. 19 is a block diagram showing the structure of the integrated recording/reproduction device according to an embodiment 6 of the present invention.

FIG. 20 is a flowchart showing the Move function improved in reliability in the integrated recording/reproduction device according to the embodiment 6 of the present invention.

FIG. 21 is a flowchart showing a copy suppressing procedure according to the embodiment of the present invention.

FIG. 22 is a block diagram showing the structure of the case (type 2) of connecting two recording/reproduction devices incorporating one or more recording devices according to an embodiment 7 of the present invention.

FIG. 23 is a flowchart showing a Move function improved in reliability of the case (type 2) of connecting two recording/reproduction devices incorporating one or more recording devices or recording media according to an embodiment 7 of the present invention.

### DESCRIPTION OF SIGNS AND NUMERALS

1 Integrated recording/reproduction device
2a, 2b Recording device
3a, 3b Unique ID
4 Content data processing device
5a, 5b Read/write control section
6 Unique ID reading means
7 Mutual ID creating means
8 Encrypting means
9 Reproduction suppressing means
10 Decryption suppressing means
11 Decrypting means
12, 13, 14 Mutual ID
18a, 18b Recording/reproduction device
19a, 19b Recording device
20a, 20b Unique ID
21a, 21b Content data processing device
22a, 22b Read/write control section
23a, 23b Unique ID reading means
24a, 24b Mutual ID creating means
25a, 25b Encrypting means
26a, 26b Reproduction suppressing means
27a, 27b Decryption suppressing means
28a, 28b Decrypting means
40a to 40c Recording/reproduction device
41a to 40c Recording device
42a to 42c Unique ID
43a to 43c Content data processing device
44a to 44c Read/write control section
45a to 45c Unique ID reading means
46a to 46c Mutual ID creating means
47a to 47c Encrypting means
48a to 48c Reproduction suppressing means
49a to 49c Decryption suppressing means
50a to 50c Decrypting means
51a, 51b Content data processing device
52a, 52b Read/write control section
53a, 53b Unique ID reading means
54a, 54b Mutual ID creating means
55a, 55b Encrypting means
56a, 56b Reproduction suppressing means
57a, 57b Decryption suppressing means
58a, 58b Decrypting means.
59a, 59b, 60 Copy suppressing means

### BEST MODE FOR CARRYING OUT THE INVENTION

Hereunder, preferred embodiments of a content data processing device of the present invention will be explained based on the drawings.

### EMBODIMENT 1

An explanation will be given to a Move function improved in reliability in an integrated recording/reproduction device 1 (type 1) incorporating two or more recording devices or recording media. As an example, the explanation is given by defining a first recording device 2a as an HDD, and defining a second recording device 2b as a DVD-RAM.

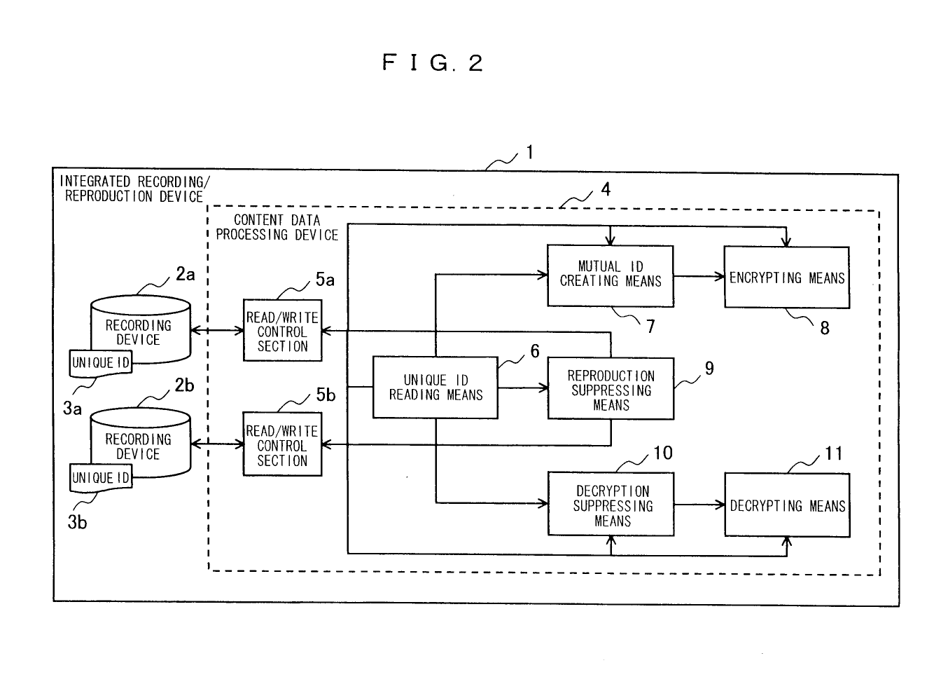

FIG. 2 is a block diagram showing a structure of an integrated recording/reproduction device 1 (type 1) according to an embodiment 1 of the present invention.

The integrated recording/reproduction device 1 is composed of first and second recording devices 2a and 2b, unique IDs 3a and 3b of the first and second recording devices 2a and 2b, and a content data processing device 4. The content data processing device 4 comprises first and second read/write control sections 5a and 5b for controlling reading/writing to the first and second recording devices 2a and 2b, a unique ID reading means 6 for reading unique ID of the recording device, a mutual ID creating means 7 for creating a mutual ID from the unique IDs 3a and 3b of the first and second recording devices 2a and 2b, an encrypting means 8 for encrypting a content by using the mutual ID, a reproduction suppressing means 9 for permitting a reproduction of an encrypted content only when the mutual ID and the unique ID are collated and corresponded to each other, a decryption suppressing means 10 for permitting a decryption of the encrypted content only when the mutual ID and the unique ID are collated and corresponded to each other, and a decrypting means 11 for decrypting the encrypted content by using the mutual ID.

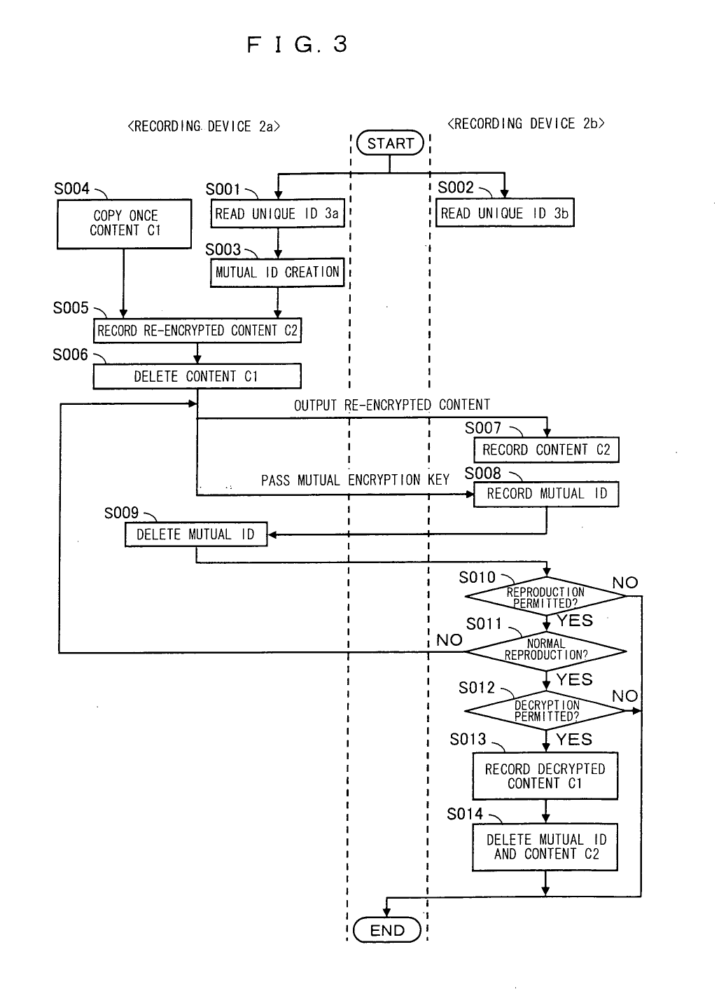

FIG. 3 is a flow chart showing the Move function improved in reliability in the integrated recording/reproduction device 1 (type 1) according to an embodiment 1 of the present invention.

Here, a copy once content C1 is assumed to be recorded in the first recording device 2a (S004).

In the unique ID reading means 6, the unique ID 3a is read from the first recording device 2a, and the unique ID 3b is read from the second recording device 2b (S001 and S002). For example, as the unique ID, an equipment ID can be used in a case of the HDD, and a disk individual ID written on the BCA can be used in a case of the DVD-RW.

In the mutual ID creating means 7, the mutual ID is created by using two unique IDs read by the unique ID reading means 6 (S003).

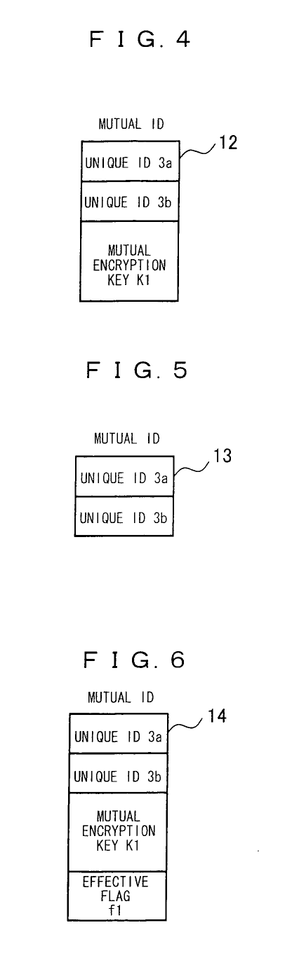

The structure of the mutual ID may be the structure such as a mutual ID 12 of FIG. 4. Two unique IDs 3a and 3b read from the first recording device 2a and the second recording device 2b and a mutual encryption key K1 created from the two unique IDs 3a and 3b are the elements of the mutual ID 12. Alternately, the mutual encryption key K1 may serve as a public key.

Alternately, the structure of the mutual ID may be the structure such as a mutual ID 13 as shown in FIG. 5. Two unique IDs 3a and 3b read from the first recording devices 2a and the second recording device 2b are the elements of the mutual ID 13. The two unique IDs 3a and 3b are consecutive data to create the mutual encryption key K1.

Alternately, the structure of the mutual ID may be the structure such as a mutual ID 14 as shown in FIG. 6. The unique IDs 3a and 3b read from the first recording device 2a and the second recording device 2b, and the mutual encryption key K1 created from the two unique IDs 3a and 3b are elements of the mutual ID 14. Alternately, the mutual encryption key K1 may be the public key. Further, an effective flag is set ON. When the mutual ID 14 is moved, a copy is created only when there is no mutual ID 14 in a moving destination, and when the mutual ID 14 is recorded, an original effective flag is set OFF, and then a moving destination flag is set ON.

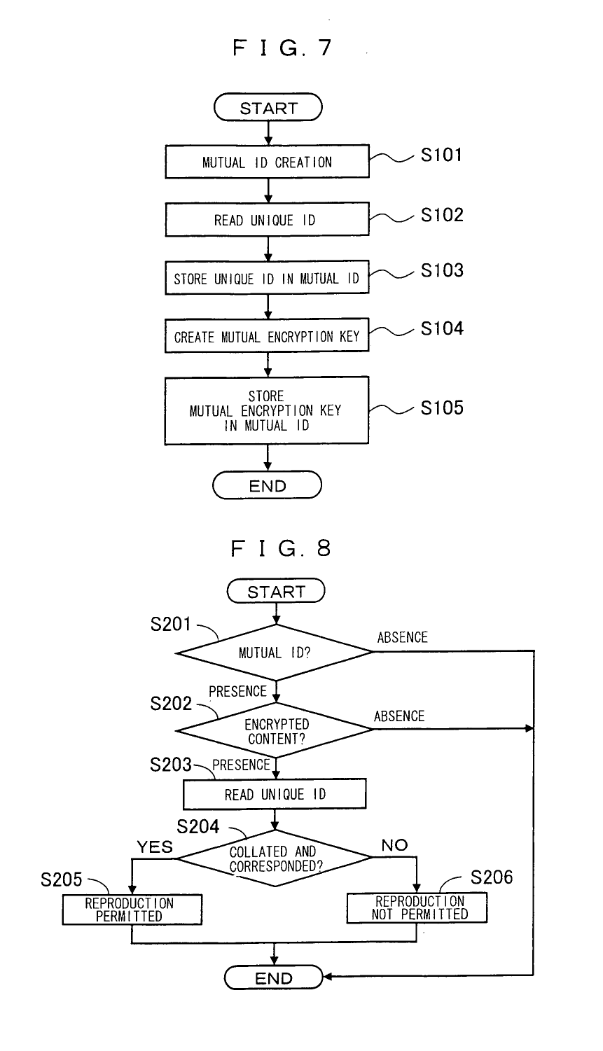

FIG. 7 is a flowchart showing a mutual ID creation procedure. The mutual ID creating means 7 stores the unique IDs 3a and 3b read by the unique ID reading means 6 (S102) in the mutual ID of variables (S103), and next, creates the mutual encryption key K1 from the two unique IDs 3a and 3b (S104), and stores it in the mutual ID (S105).

By using the mutual encryption key K1 thus created, a copy once content C1 recorded in the first recording device 2a is encrypted and an encrypted content C2 is recorded (S005). Next, the copy once content C1 is deleted (S006). Here, since both of the mutual ID and the encrypted content C2 are recorded in the first recording device 2a, the encrypted content C2 can be reproduced.

In the reproduction suppressing means 9, the mutual ID and the unique ID are collated and only when they correspond to each other, the reproduction of the encrypted content is permitted.

FIG. 8 is a flowchart showing the reproduction suppressing procedure. The reproduction suppressing means 9 reads the unique IDs of the recording device (S203) in the recording device in which both of the mutual ID and the encrypted content C2 are recorded (S201, 202), and permits the reproduction when the unique ID of the recording device and either one of the two unique IDs in the mutual ID corresponds to each other (S205), and does not permit the reproduction when they do not correspond to each other (S206).

The unique ID in the mutual ID recorded in the first recording device 2a and the unique ID 3a of the first recording device 2a correspond to each other, and therefore the reproduction is permitted.

The encrypted content C2 recorded in the first recording device 2a is copied to the second recording device 2b (S007).

Further, the mutual ID recorded in the first recording device 2a is copied to the second recording device 2b (S008), and the mutual ID recorded in the first recording device 2a is deleted (S009). As a result, the encrypted content C2 is in a state of being recorded not only in the first recording device 2a but also in the second recording device 2b. However, since the mutual ID is already deleted in the first recording device 2a, the encrypted content C2 cannot be reproduced.

In the reproduction suppressing means 9, the unique ID in the mutual ID recorded in the second recording device 2b and the unique ID 3b of the second recording device 2b correspond to each other, and therefore the reproduction is permitted (S010), and whether or not a normal copying is performed is confirmed by the reproduction (S011).

In a case of a normal copy, the encryption content C2 recorded in the first recording device 2a may be deleted.

In the encryption suppressing means 10, the decryption of the encrypted content is permitted only when the mutual ID and the unique ID are collated and corresponded to each other.

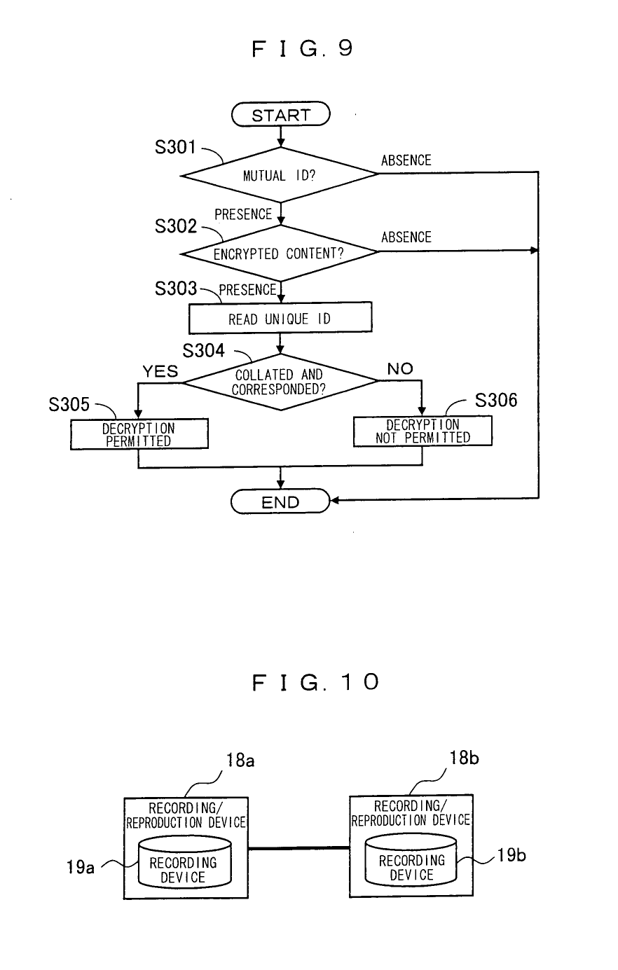

FIG. 9 is a flowchart showing a decryption suppressing procedure. In the recording device in which both of the mutual ID and the encrypted content C2 are recorded (S301 and S302), the decryption suppressing means 9 reads the unique ID of the recording device (S303), and when the unique ID of the recording device and either one of the two unique IDs in the mutual ID correspond to each other (S304), the decryption is permitted (S305), and when they do not corresponded to each other, the decryption is not permitted (S306).

The decryption suppressing means 10 permits the decryption, because the unique ID in the mutual ID recorded in the second recording device 2b and the unique ID 3b of the second recording device 2b correspond to each other (S012).

In the decrypting means 11, the encrypted content C2 is decrypted by using the mutual encryption key K1 in the mutual ID, and the copy once content C1 is recorded in the second recording device 2b (S013).

The encrypted content C2 and the mutual ID recorded in the second recording device 2b are deleted (S014).

### EMBODIMENT 2

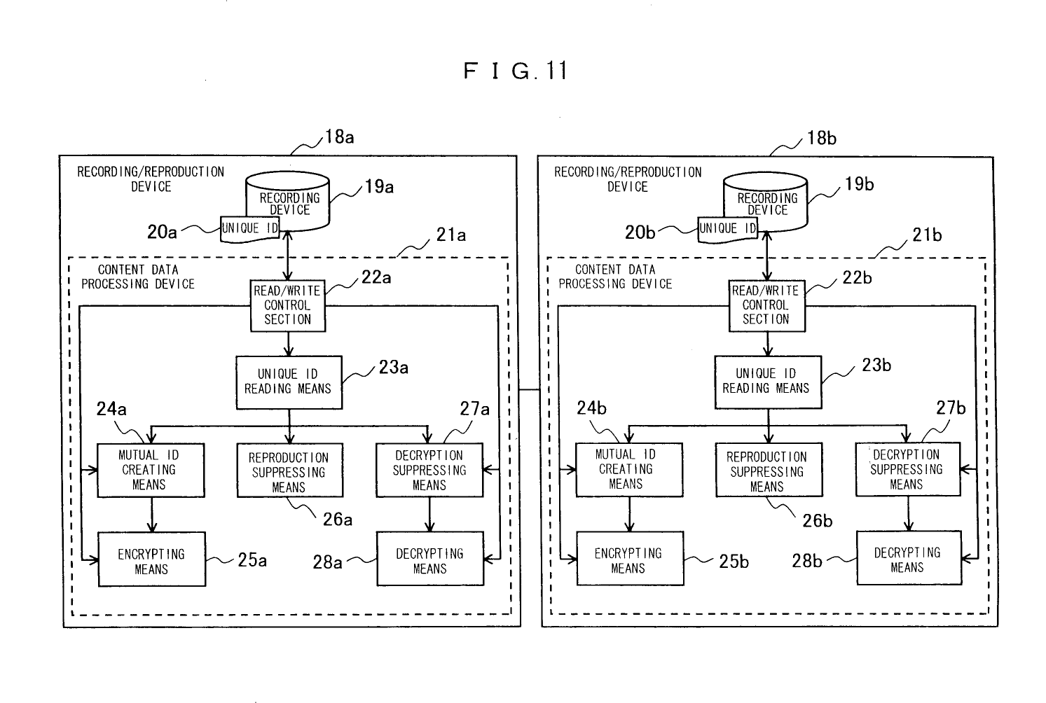

An explanation will be given to the Move function improved in reliability in a case (type 2) of connecting two recording/reproduction devices such as first and second recording/reproduction devices 18a and 18b incorporating one or more recording devices or recording media as shown in FIG. 10.

For example, connection between devices may be IEEE1394DTCP.

FIG. 11 is a block diagram showing a structure of the case (type 2) of connecting two recording/reproduction devices such as first and second recording/reproduction devices 18a and 18b incorporating one or more recording devices according to an embodiment 2 of the present invention.

The two recording/reproduction devices are composed of first and second recording devices 19a and 19b, unique IDs 20a and 20b of the first and second recording devices 19a and 19b, and first and second content data processing devices 22a and 22b. The first and second content data processing devices 22a and 22b are composed of first and second read/write control sections 22a and 22b for controlling reading/writing to the first and second recording devices 19a and 19b; first and second unique ID reading means 23a and 23b for reading the unique ID of the recording device; first and second mutual ID creating means 24a and 24b for creating the mutual ID from the unique ID of the recording device; first and second encrypting means 25a and 25b for encrypting the content by using the mutual ID; first and second reproduction suppressing means 26a and 26b for permitting the reproduction of the encrypted content only when the mutual ID and the unique ID are collated and corresponded to each other; first and second decryption suppressing means 27a and 27b for permitting the decryption of the encrypted content only when the mutual ID and the unique ID are collated and corresponded to each other; and first and second decrypting means 28a and 28b for decrypting the encrypted content by using the mutual ID.

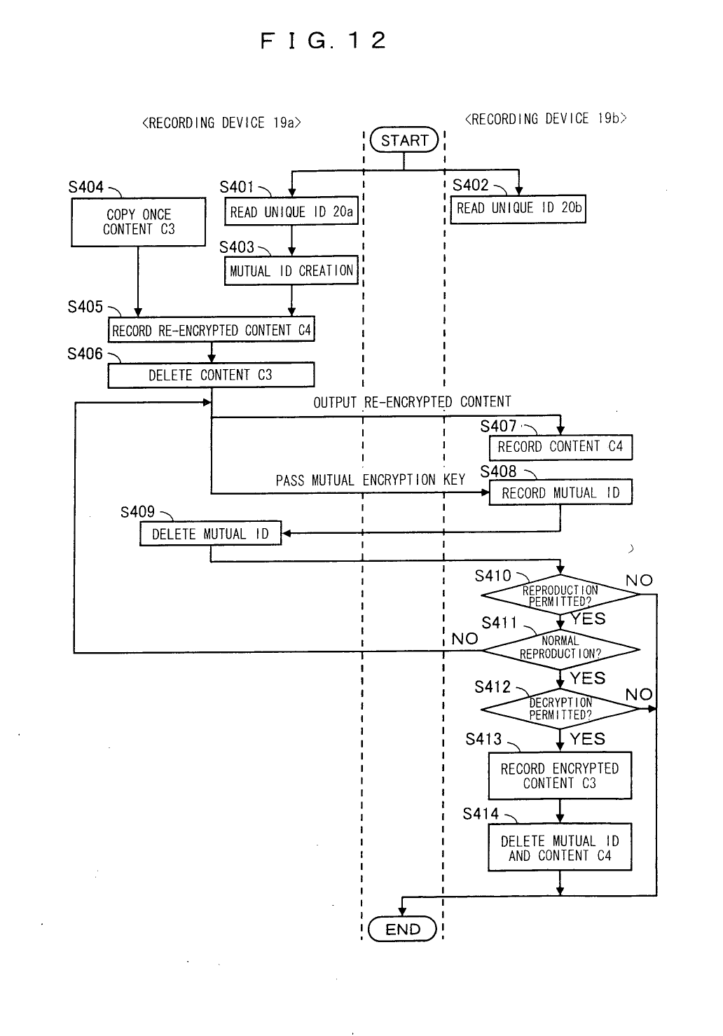

FIG. 12 is a flowchart showing the Move function improved in reliability in the case (type 2) of connecting two recording/reproduction devices such as first and second recording/reproduction devices 18a and 18b incorporating one or more recording devices according to an embodiment 2 of the present invention.

Here, a copy once content C3 is assumed to be recorded in the first recording device 19a (S404).

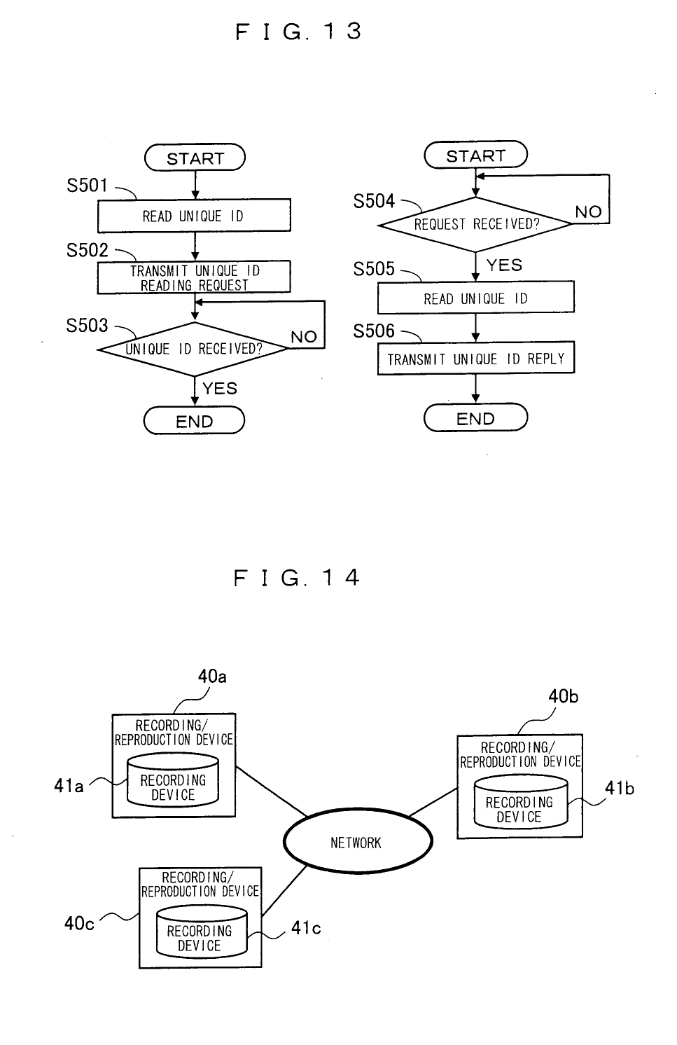

FIG. 13 is a flowchart showing a unique ID reading procedure of the case (type 2) of connecting two recording/reproduction devices incorporating one or more recording/reproduction devices.

The unique ID reading means reads the unique ID from the recording device (S501), transmits a unique ID request to a connected recording device (S502), and waits for the unique ID from the connected recording device (S503). Further, when the unique ID request is received from other unique ID reading means (S504), the unique ID is read from the recording device (S505), and a value of the unique ID of the connected recording device is replied (S506).

In the first unique ID reading means 23a, a unique ID 20a is read from the first recording device 19a (S401), and a unique ID reading request is transmitted to the second unique ID reading means 23b. In the second unique ID reading means 23b, a unique ID 20b is read from the second recording device 19b (S402), and the read unique ID 20b is replied to the first unique ID reading means 23a.

In the first mutual ID creating means 24a, the mutual ID is created by using the two unique IDs 20a and 20b read by the first and second unique ID reading means 23a and 23b. A mutual ID creation method is the same as that of the embodiment 1.

The two unique IDs 20a and 20b read by the first and second unique ID reading means 23a and 23b are stored in the mutual ID of variables, and next, a mutual encryption key K2 is created from the two unique IDs 20a and 20b, and it is stored in the mutual ID (S403).

By using the created mutual encryption key K2, the copy once content C3 recorded in the first recording device 19a is encrypted and an encrypted content C4 is recorded in the recording device (S405). Thereafter, the copy once content C3 is deleted (S406). Thus, only when both of the mutual ID and the encrypted content C4 are recorded in the recording device, the reproduction can be performed.

In the first reproduction suppressing means 26a, only when the mutual ID and the unique ID are collated and corresponded to each other, the reproduction of the encrypted content C4 is permitted. The reproduction suppressing procedure is the same as that of the embodiment 1.

Since the unique ID in the mutual ID recorded in the first recording device 19a and the unique ID 20a of the first recording device 19a correspond to each other, the reproduction of the encrypted content C4 is permitted.

The encrypted content C4 recorded in the first recording device 19a is copied to the second recording device 19b (S407).

Further, the mutual ID recorded in the first recording device 19a is copied to the second recording device 19b (S408), and the mutual ID recorded in the first recording device 19a is deleted (S409). Thus, the encrypted content C4 recorded in the first recording device 19a cannot be reproduced.

In the second reproduction suppressing means 26b, the unique ID in the mutual ID recorded in the second recording device 19b and the unique ID 20b of the second recording device 19b correspond to each other, therefore the reproduction is permitted (S410), and whether or not the content can be normally copied is confirmed by the reproduction (S411).

In the case of the normal copy, the encrypted content C4 recorded in the first recording device 19a may be deleted.

In the second decryption suppressing means 27b, only when the mutual ID and the unique ID are collated and corresponded to each other, the decryption of the encrypted content is permitted. The decryption suppressing procedure is the same as that of the embodiment 1.

Since the unique ID in the mutual ID recorded in the second recording device 19b and the unique ID 20b of the second recording device 19b correspond to each other, and therefore the decryption of the encrypted content C4 is permitted (S412).

In the second decrypting means 28b, the encrypted content C4 is decrypted by using the mutual encryption key K2 in the mutual ID, and the copy once content C3 is recorded in the second recording device 19b (S413).

The encrypted content C4 and the mutual ID recorded in the second recording device 19b are deleted (S414). EMBODIMENT 3

An explanation will be given to a network (type 3) of connecting two or more recording/reproduction devices incorporating one or more recording devices or recording media as shown in FIG. 14.

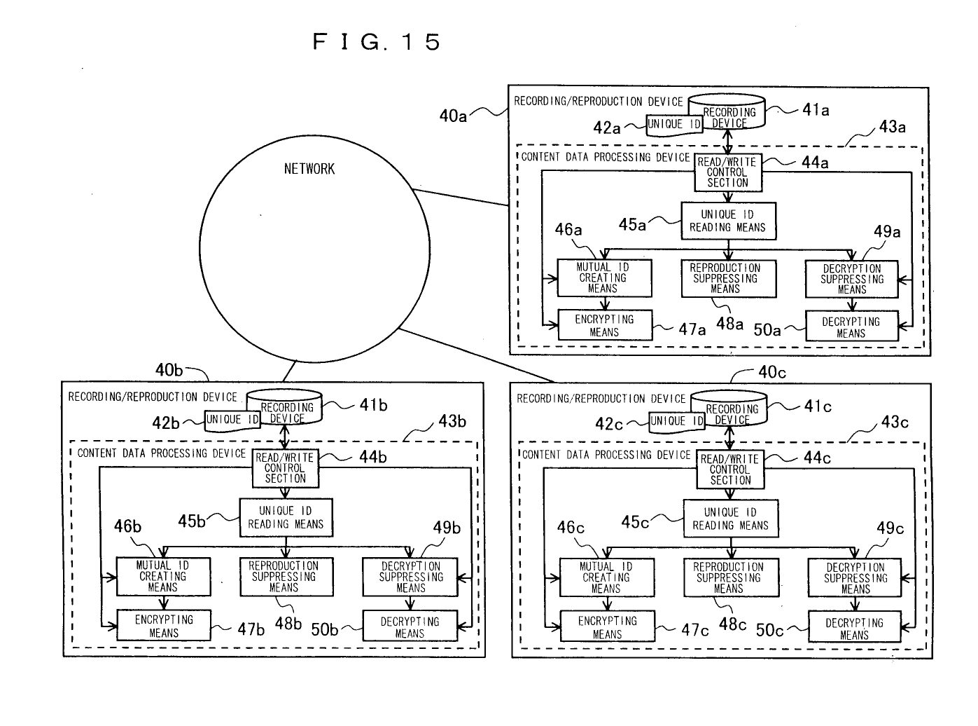

FIG. 15 is a block diagram showing the structure of the network of connecting two or more recording/reproduction devices 40a, 40b, 40c incorporating one or more recording devices according to the embodiment 3 of the present invention.

This network is constituted of first to third recording devices 41a, 41b, 41c, and unique IDs 42a, 42b, 42c of the first to third recording devices 41a, 41b, 41c, and first to third content data processing devices 43a, 43b, 43c. The structure of the content data processing device is the same as that of the embodiment 2, and therefore the explanation thereof is omitted.

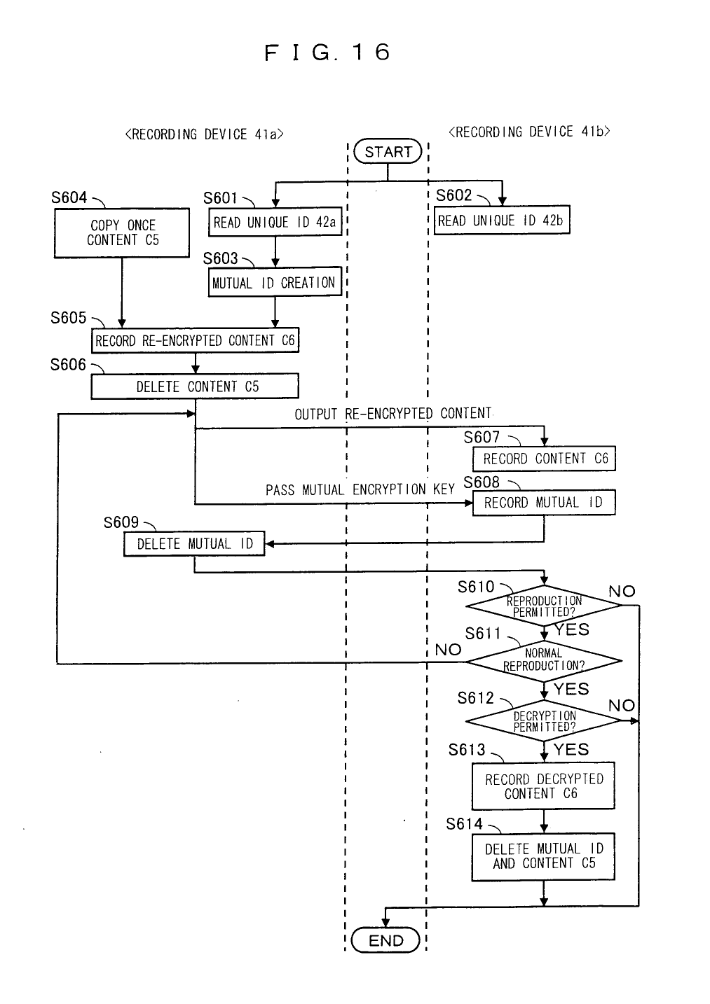

FIG. 16 is a flowchart showing the Move function improved in reliability in the network (type 3) of connecting two or more recording/reproduction devices 40a, 40b, 40c incorporating one or more recording devices according to the embodiment 3 of the present invention.

Here, a copy once content C5 is recorded in the first recording device 41a (S604), and the Move is performed between the first and second recording/reproduction devices 40a and 40b.

In the flowchart showing the unique ID reading procedure of FIG. 13, it is assumed that the unique ID request can be transmitted by designating a device connected to the network, and when the unique ID request is received, it is replied by designating the device.

The unique ID reading method is the same as that of the embodiment 2.

In the first unique ID reading means 45a, the unique ID 42a is read from the first recording device 41a (S601), and the unique ID reading request is transmitted to the second unique ID reading means 45b. In the second unique ID reading means 45b, the unique ID 42b is read from the second recording device 41b (S602) and it is replied to the first unique ID reading means 45a.

In the first mutual ID creating means 46a, the mutual ID is created by using the two unique IDs 42a and 42b read by the first and second reading means 45a and 45b. The mutual ID creating method is the same as that of the embodiment 1.

The two unique IDs 42a and 42b read by the first and second unique ID reading means 45a and 45b are stored in the mutual ID of variables, and next, a mutual encryption key K3 is created from the two unique IDs 42a and 42b, and the mutual encryption key K3 is stored in the mutual ID (S603).

By using the mutual encryption key K3 thus created, a copy once content CS recorded in the first recording device 41a is encrypted and an encrypted content C6 is recorded in the recording device (S605), and thereafter, the copy once content CS is deleted (S606). Thus, only when both of the mutual ID and the encrypted content C6 are recorded in the recording device, the reproduction can be performed.

In the first reproduction suppressing means 48a, only when the mutual ID and the unique ID are collated and corresponded to each other, the reproduction of the encrypted content C6 is permitted. The reproduction suppressing procedure is the same as that of the embodiment 1.

The unique ID in the mutual ID recorded in the first recording device 41a and the unique ID 42a of the first recording device 41a correspond to each other, and therefore the reproduction of the encrypted content C6 is permitted.

The encrypted content C6 recorded in the first recording device 41a is copied to the second recording device 41b (S607).

Further, the mutual ID recorded in the first recording device 41a is copied to the second recording device 41b (S608), and the mutual ID recorded in the first recording device 41a is deleted (S609). Thus, the encrypted content C6 recorded in the first recording device 41a cannot be reproduced.

In the second reproduction suppressing means 48b, the unique ID in the mutual ID recorded in the second recording device 41b and the unique ID 42b of the second recording device 41b correspond to each other, and therefore the reproduction is permitted (S610), and whether or not a normal copy can be made is confirmed by the reproduction (S611).

In the case of the normal copy, the encrypted content C6 recorded in the first recording device 41a may be deleted.

In the second decryption suppressing means 49b, only when the mutual ID and the unique ID are collated and only when they correspond to each other, the decryption of the encrypted content is permitted. The decryption suppressing procedure is the same as that of the embodiment 1.

The unique ID in the mutual ID recorded in the second recording device 41b and the unique ID 42b of the second recording device 41b correspond to each other, and therefore the decryption of the decrypted content C6 is permitted (S612).

In the second decrypting means 50b, by using the mutual encryption key K3 in the mutual ID, the encrypted content C6 is decrypted, and the copy once content CS is recorded in the second recording device 41b (S613).

The encrypted content C6 and the mutual ID recorded in the second recording device 41b are deleted (S614).

### EMBODIMENT 4

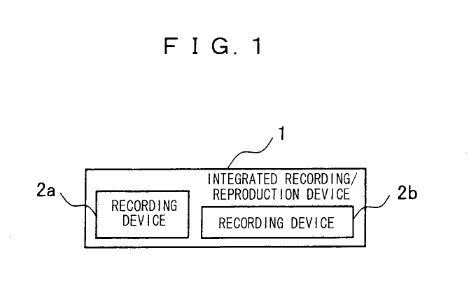

An explanation will be given to the Move Back function in an integrated recording/reproduction device 1 (Type 1) incorporating two or more recording devices and recording media as shown in FIG. 1.

However, this function is regarded as ineffective, because the mutual ID cannot be deleted.

The structure of the integrated recording/reproduction device 1 in an embodiment 4 of the present invention uses the same FIG. 2 of the embodiment 1.

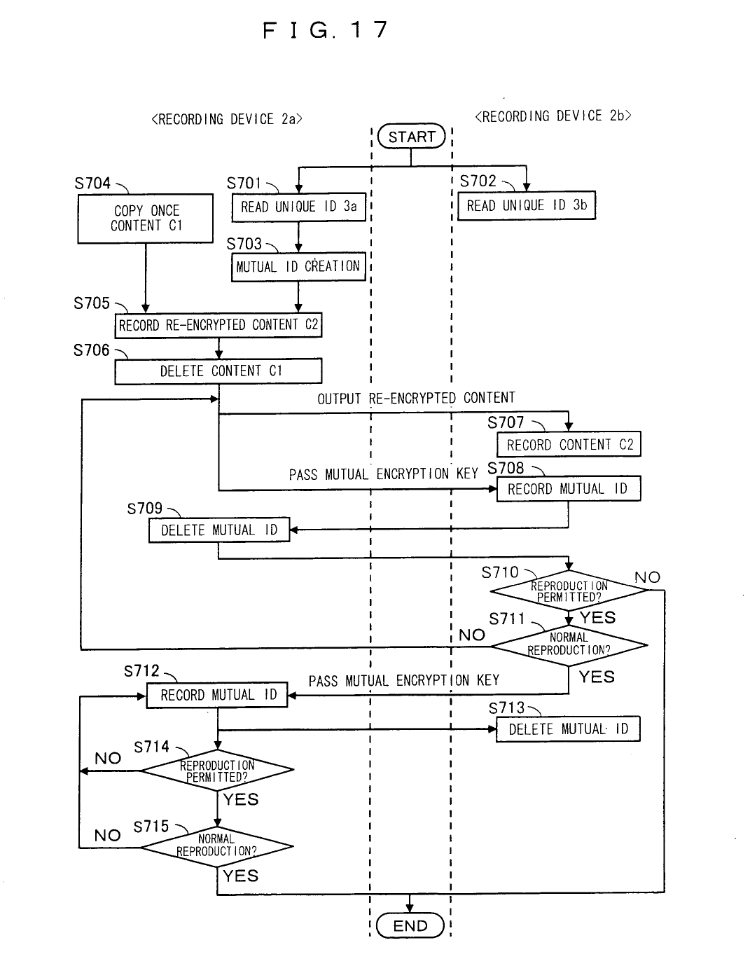

FIG. 17 is a flowchart showing the Move Back function in the integrated recording/reproduction device 1 (type 1) in the embodiment 4 of the present invention.

Here, it is assumed that the copy once content C1 is recorded in the first recording device 2a (S704).

In the unique ID reading means 6, the unique ID 3a is read from the first recording device 2a, and the unique ID 3b is read from the second recording device 2b (S701 and S702).

In the mutual ID creating means 7, the mutual ID is created by using the unique IDs 3a and 3b read by the unique ID reading means 6. The mutual ID creating method is the same as that of the embodiment 1.

The two unique IDs 3a and 3b read by the unique ID reading means 6 are stored in the mutual ID of variables, and next the mutual encryption key K1 is created from the unique IDs 3a and 3b, and this encryption key K1 is stored in the mutual ID (s703).

By using the mutual encryption key K1 thus created, the copy once content C1 recorded in the first recording device 2a is encrypted and the encrypted content C2 is recorded (S705), and thereafter, the copy once content C1 is deleted (S706). Thus, only when both of the mutual ID and the encrypted content C2 are recorded in the recording device, the reproduction can be performed.

In the reproduction suppressing means 9, only when the mutual ID and the unique ID are collated and corresponded to each other, the encrypted content is permitted to be reproduced. The reproduction suppressing procedure is the same as that of the embodiment 1.

The unique ID in the mutual ID recorded in the first recording device 2a and the unique ID 3a of the first recording device 2a correspond to each other, and therefore the reproduction is permitted.

The encrypted content C2 recorded in the first recording device 2a is copied to the second recording device 2b (S707).

Further, the mutual ID recorded in the first recording device 2a is copied to the second recording device 2b (S708), and the mutual ID recorded in the first recording device 2a is deleted (S709). Thus, the encrypted content C2 recorded in the first recording device 2a cannot be reproduced.

In the reproduction suppressing means 9, the unique ID in the mutual ID recorded in the second recording device 2b and the unique ID 3b of the second recording device 2b correspond to each other. Therefore, the reproduction is permitted (S710), and whether or not a normal copy can be made is confirmed by the reproduction (S711).

In the case of the normal copy, the mutual ID recorded in the second recording device 2b is copied to the first recording device 2a (S712), and the mutual ID recorded in the second recording device 2b is deleted (S713). Thus, the encrypted content C2 recorded in the second recording device 2b cannot be reproduced.

In the reproduction suppressing means 9, the unique ID in the mutual ID recorded in the first recording device 2a and the unique ID 3a of the first recording device 2a correspond to each other, and therefore the reproduction is permitted (S714).

Thereafter, a reproduction right of the encrypted content C2 is moved by a movement of the mutual ID. When the mutual ID is recorded in the first recording device 2a and the reproduction of the encrypted content C2 is possible, the encrypted content C2 recorded in the second recording device 2b becomes backup data. Meanwhile, when the mutual ID is recorded in the second recording device 2b, the encrypted content C2 recorded in the first recording device 2a becomes the backup data. EMBODIMENT 5

An explanation will be given to an irreversible conversion Move function in the integrated recording/reproduction device 1 (type 1) incorporating two or more recording devices and recording media as shown in FIG. 1.

However, this function is not capable of deleting the mutual ID, and therefore it is not effective in a case of write once media.

The structure of the integrated recording/reproduction device 1 according to an embodiment 5 of the present invention uses the same FIG. 2 of the embodiment 1.

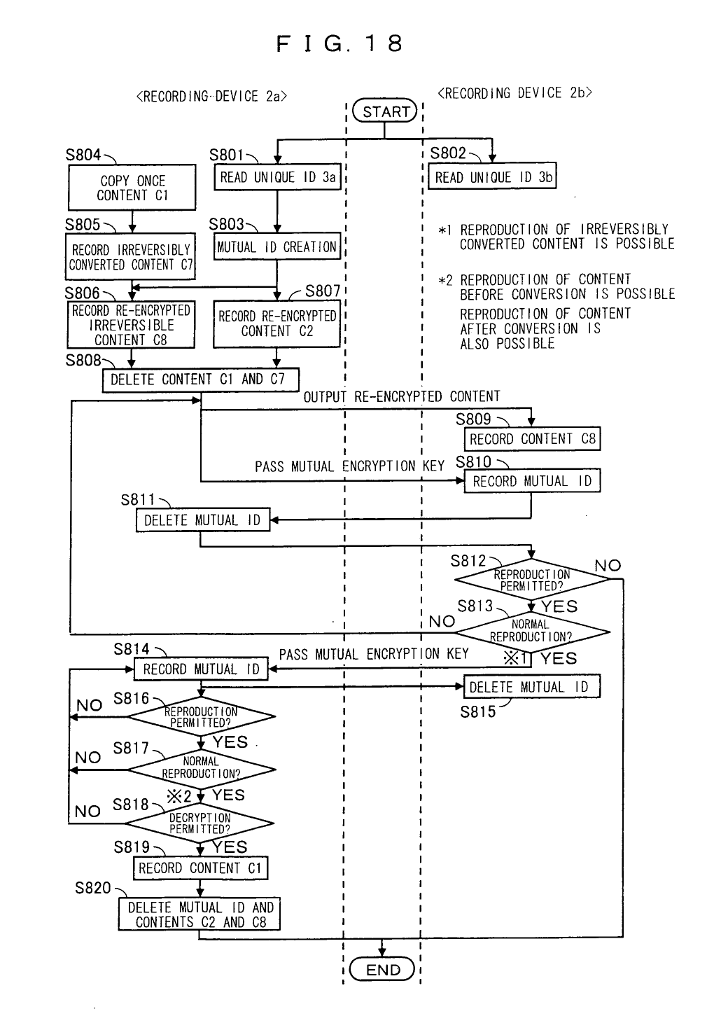

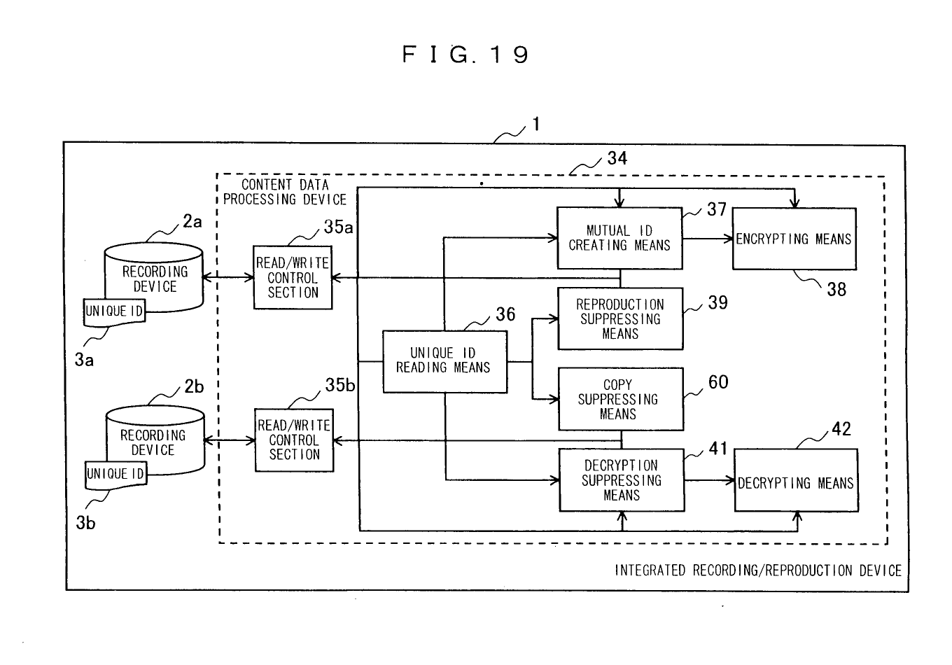

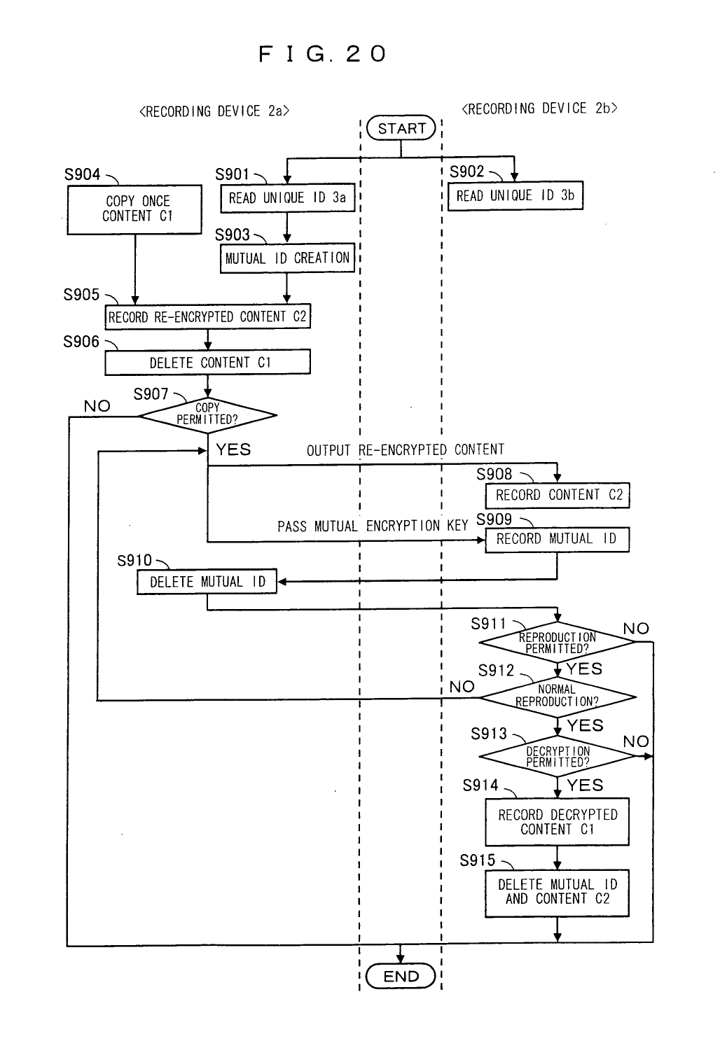

FIG. 18 is a flowchart showing the irreversible conversion Move function in the integrated recording/reproduction device 1 (type 1) in the embodiment 5 of the present invention.

Here, it is assumed that the copy once content C1 is recorded in the first recording device 2a (S804).

In the unique ID reading means 6, the unique ID 3a is read from the first recording device 2a, and the unique ID 3b is read from the second recording device 2b (S801 and S802).

In the mutual ID creating means 7, the mutual ID is created by using the two unique IDs 3a and 3b read by the unique ID reading means 6. The mutual ID creating method is the same as that of the embodiment 1.

The two unique IDs 3a and 3b read by the unique ID reading means 6 are stored in the mutual ID of variables, and next, the mutual encryption key K1 is created from the two unique IDs 3a and 3b, and this mutual encryption key K1 is stored in the mutual ID (S803).

Here, the irreversible conversion such as a low data rate and a different compression system is performed, and an irreversibly converted content S7 is recorded in the recording device (S805).

The copy once content C1 and the irreversibly converted content C7 recorded in the first recording device 2a are encrypted by using the created mutual encryption key K1 and the encrypted content C2 and the irreversibly converted encrypted content C8 are recorded in the recording device (S806 and S807). Thereafter, the copy once content C1 and the irreversibly converted content C7 are deleted (S808). Thus, only when the mutual ID and the encrypted content C2 or the irreversibly converted encrypted content C8 are recorded in the recording device, the reproduction can be performed.

In the reproduction suppressing means 9, only when the mutual ID and the unique ID are collated and corresponded to each other, the reproduction of the encrypted content is permitted. The reproduction suppressing procedure is the same as that of the embodiment 1.

The unique ID in the mutual ID recorded in the first recording device 2a and the unique ID 3a of the first recording device 2a correspond to each other, and therefore the reproduction of the encrypted content C2 and the irreversibly converted encrypted content C8 is permitted.

The irreversibly converted encrypted content C8 recorded in the first recording device 2a is copied to the second recording device 2b (S809).

Further, the mutual ID recorded in the first recording device 2a is copied to the second recording device 2b (S810), and the mutual ID recorded in the first recording device 2a is deleted (S811). Thus, the encrypted content C2 recorded in the first recording device 2a cannot be reproduced.

In the reproduction suppressing means 9, the unique ID in the mutual ID recorded in the second recording device 2b and the unique ID 3b of the second recording device 2b correspond to each other, and therefore the reproduction is permitted (S812), and whether or not the normal copy can be made is confirmed by the reproduction (S813).

At this time, in the second recording device 2b, it is possible to reproduce the content C8 that has undergone the irreversible conversion such as low data rate and compression system.

The mutual ID recorded in the second recording device 2b is copied to the first recording device 2a (S814), and the mutual ID recorded in the second recording device 2b is deleted (S815). Thus, the irreversibly converted encrypted content C8 recorded in the second recording device 2b cannot be reproduced.

The unique ID in the mutual ID recorded in the first recording device 2a and the unique ID 3a of the first recording device 2a correspond to each other, and therefore the reproduction of the encrypted content C2 and the irreversibly converted encrypted content C8 is permitted (S816).

At this time, it is possible to reproduce the encrypted content C2 of high quality before undergoing the irreversible conversion. In addition, it is also possible to reproduce the irreversibly converted encrypted content CB that has undergone the irreversible conversion (S817).

Here, the irreversibly converted encrypted content C8 recorded in the second recording device 2b may be deleted.

In the decryption suppressing means 10, only when the mutual ID and the unique ID are collated and corresponded to each other, the decryption of the encrypted content is permitted. The decryption suppressing procedure is the same as that of the embodiment 1.

Since the unique ID in the mutual ID recorded in the first recording device 2a and the unique ID 3a of the first recording device 2a correspond to each other, the decryption is permitted (S818).

In the decrypting means 14, by using the mutual encryption key K1 in the mutual ID, the encrypted content C2 is decrypted, and the copy once content C1 is recorded in the first recording device 2a (S819).

The encrypted content C2, the irreversibly converted encrypted content C8, and the mutual ID recorded in the first recording device 2a are deleted (S820).

### EMBODIMENT 6

An explanation will be given to the Move function improved in reliability in the integrated recording/reproduction device 1 (type 1) incorporating two or more recording devices or recording media as shown in FIG. 1.

FIG. 19 is a block diagram showing the structure of the integrated recording/reproduction device 1 in an embodiment 6 of the present invention.

The integrated recording/reproduction device 1 is composed of the first and second recording devices 2a and 2b, the unique IDs 3a and 3b of the first and second recording devices 2a and 2b, and a content data processing device 34. The content data processing device 34 is composed of first and second read/write control sections 35a and 35b for controlling the reading/writing to the first and second recording devices 2a and 2b, an unique ID reading means 36 for reading the unique ID of the recording device, a mutual ID creating means 37 for creating the mutual ID from the unique ID of the recording device, an encrypting means 38 for encrypting the content by using the mutual ID, a reproduction suppressing means 39 for permitting the reproduction of the encrypted content only when the mutual ID and the unique ID are collated and corresponded to each other, a copy suppressing means 60 for permitting the copy of the encrypted content only when the mutual ID and the unique ID are collated and corresponded to each other, a decryption suppressing means 41 for permitting the decryption of the encrypted content only when the mutual ID and the unique ID are collated and corresponded to each other, and a decrypting means 42 for decrypting the encrypted content by using the mutual ID.

FIG. 20 is a flowchart showing the Move function improved in reliability in the integrated recording/reproduction device 1 (type 1) in the embodiment 6 of the present invention.

Here, it is assumed that the copy once content C1 is recorded in the first recording device 2a (S904).

In the unique ID reading means 36, the unique ID 3a is read from the first recording device 2a, and the unique ID 3b is read from the second recording device 2b (S901 and S902).

In the mutual ID creating means 37, the mutual ID is created by using the two unique IDs 3a and 3b read by the unique ID reading means 36. The mutual ID creating method is the same as that of the embodiment 1.

The two unique IDs 3a and 3b read by the unique ID reading means 36 are stored in the mutual ID of variables, and next, the mutual decryption key K1 is created from the two unique IDs 3a and 3b, and this mutual encryption key K1 is stored in the mutual ID (S903).

By using the mutual decryption key K1 thus created, the copy once content C1 recorded in the first recording device 2a is encrypted and the encrypted content C2 is recorded in the recording device (S905), and thereafter the copy once content C1 is deleted (S906). Thus, only when both of the mutual ID and the encrypted content C2 are recorded in the recording device, the reproduction can be performed.

In the reproduction suppressing means 39, only when the mutual ID and the unique ID are collated and corresponded to each other, the reproduction of the encrypted content is permitted. The reproduction suppressing method is the same as that of the embodiment 1.

The unique ID in the mutual ID recorded in the first recording device 2a and the unique ID 3a of the first recording device 2a correspond to each other, and therefore the reproduction is permitted.

In the copy suppressing means 60, only when the mutual ID and the unique ID are collated and corresponded to each other, the reproduction of the encrypted content is permitted.

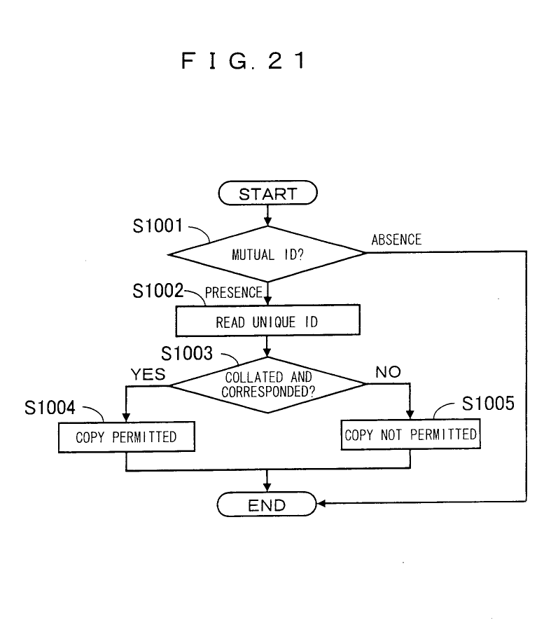

FIG. 21 is a flowchart showing the copy suppressing procedure. In the recording device in which the mutual ID is recorded (S1001), the unique ID of the recording device, which is the copy destination of the encrypted content, is read (S1002). When the unique ID of the recording device, which is the copy destination, and either one of the two unique IDs in the mutual ID correspond to each other (S1003), the copy is permitted (S1004), and when they do not correspond to each other, the copy is not permitted (S1005).

The unique ID in the mutual ID recorded in the first recording device 2a and the unique ID 3b of the second recording device 2b correspond to each other, and therefore the copy is permitted (S907), and the encrypted content C2 recorded in the first recording device 2a is copied to the second recording device 2b (S908).

Further, the mutual ID recorded in the first recording device 2a is copied to the second recording device 2b (S909), and the mutual ID recorded in the first recording device 2a is deleted (S910). Thus, the encrypted content C2 recorded in the first recording device 2a cannot be reproduced.

In the reproduction suppressing means 39, the unique ID in the mutual ID recorded in the second recording device 2b and the unique ID 3b of the second recording device 2b correspond to each other, and therefore the reproduction is permitted (S911), and whether or not a normal copy can be made is confirmed by the reproduction (S912).

In the case of the normal copy, the encrypted content C2 recorded in the first recording device 2a may be deleted.

In the decryption suppressing means 41, only when the mutual ID and the unique ID are collated and corresponded to each other, the decryption of the encrypted content is permitted. The decryption suppressing method is the same as that of the embodiment 1.

Since the unique ID in the mutual ID recorded in the second recording device 2b and the unique ID 3b of the second recording device 2b correspond to each other, the decryption suppressing means 41 permits the decryption (S913).

In the decrypting means 42, the encrypted content C2 is decrypted by using the mutual encryption key K1 in the mutual ID, and the copy once content C1 is recorded in the second recording device 2b (S914).

The encrypted content C2 and the mutual ID recorded in the second recording device 2b are deleted (S915).

### EMBODIMENT 7

An explanation is given to the Move function improved in reliability in the case (type 2) of connecting two recording/reproduction devices such as first and second recording/reproduction devices 18a and 18b incorporating one or more recording devices or recording media as shown in FIG. 10.

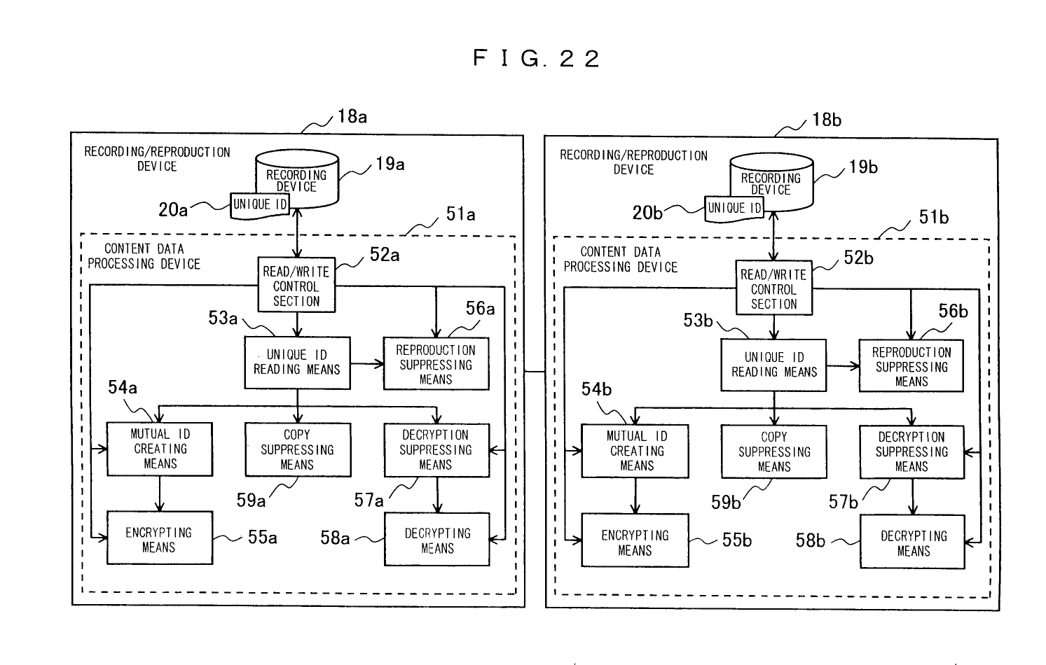

FIG. 22 is a block diagram showing the case (type 2) of connecting two recording/reproduction devices such as first and second recording/reproduction devices 18a and 18b incorporating one or more recording devices according to an embodiment 7 of the present invention.

The two recording/reproduction devices are composed of the first and second recording devices 19a and 19b, the unique IDs 20a and 20b of the first and second recording devices 19a and 19b, and first and second content data processing devices 51a and 51b. The first and second content data processing devices 51a and 5b are composed of first and second read/write control sections 52a and 52b for controlling the reading/writing to the first and second recording devices 19a and 19b, first and second unique ID reading means 53a and 53b for reading the unique ID of the recording device, first and second mutual ID creating means 54a and 54b for creating the mutual ID from the unique ID of the recording device, first and second encrypting means 55a and 55b for encrypting the content by using the mutual ID, first and second reproduction suppressing means 56a and 56b for permitting the reproduction of the encrypted content only when the mutual ID and the unique ID are collated and corresponded to each other, first and second copy suppressing means 59a and 59b for permitting the copy of the encrypted content only when the mutual ID and the unique ID are collated and corresponded to each other, first and second decryption suppressing means 57a and 57b for permitting the decryption of the encrypted content only when the mutual ID and the unique ID are collated and corresponded to each other, and first and second encrypting means 58a and 58b for decrypting the encrypted content by using the mutual ID.

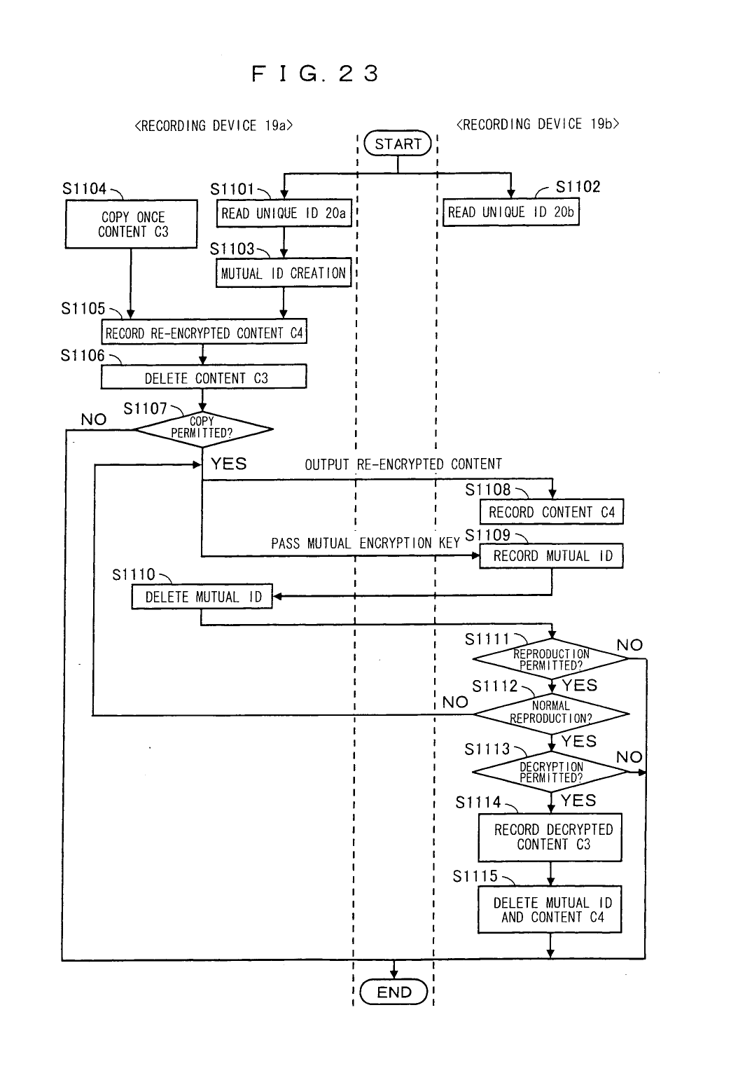

FIG. 23 is a flowchart showing the Move function improved in reliability in the case (type 2) of connecting two recording/reproduction devices such as first and second recording/reproduction devices 19a and 19b incorporating one or more recording devices according to the embodiment 7 of the present invention.

Here, it is assumed that the copy once content C1 is recorded in the first recording device 2a (S1104).

In the first and second unique ID reading means 53a and 53b, the unique ID is read from the recording device. The unique ID reading method is the same as that of the embodiment 2. In the unique ID reading means 53a, the unique ID 20a is read from the first recording device 19a, and in the second unique ID reading means 53b, the unique ID 20a is read from the first recording device 19a (S1101 and S1102).

In the first mutual ID creating means 54a, the mutual ID is created by using the two unique IDs 20a and 20b read by the first and second reading means 53a and 53b. The mutual ID creating method is the same as that of the embodiment 1.

The two unique IDs 20a and 20b read by the first and second unique ID reading means 53a and 53b are stored in the mutual ID of variables, and next the mutual encryption key K2 is created from the two unique IDs 20a and 20b and this mutual encryption key K2 is stored in the mutual ID (S1103).

The copy once content C3 recorded in the first recording device 19a is encrypted by using the created mutual encryption key K2, and the encrypted content C4 is recorded in the recording device (S1105), and there after the copy once content C3 is deleted (S1106). Thus, only when both of the mutual ID and the encrypted content C4 are recorded in the recording device, the reproduction can be performed.

In the first reproduction suppressing means 56a, only when the mutual ID and the unique ID are collated and corresponded to each other, the reproduction of the encrypted 31 content is permitted. The reproduction suppressing method is the same as that of the embodiment 1.

The unique ID in the mutual ID recorded in the first recording device 19a and the unique ID 20a of the first recording device 19a correspond to each other, and therefore the reproduction is permitted.

In the first copy suppressing means 59a, only when the mutual ID and the unique ID are collated and corresponded to each other, the reproduction of the encrypted content is permitted. The copy suppressing method is the same as that of the embodiment 5.

The unique ID in the mutual ID recorded in the first recording device 19a and the unique ID 20a of the first recording device 19a correspond to each other, and therefore the copy is permitted (S1107), and the encrypted content C4 recorded in the first recording device 19a is copied to the first recording device 19a (S1108).

Further, the mutual ID recorded in the first recording device 19a is copied to the first recording device 19a (S1109), and the mutual ID recorded in the first recording device 19a is deleted (S1110). Thus, the encrypted content C4 recorded in the first recording device 19a cannot be reproduced.

In the second reproduction suppressing means 56b, the unique ID in the mutual ID recorded in the first recording device 19a and the unique ID 20a of the first recording device 19a correspond to each other, and therefore the reproduction is permitted (S1111), and whether or not the normal copy can be made is confirmed by the reproduction (S1112).

In the case of the normal copy, the encrypted content C4 recorded in the first recording device 19a may be deleted.

In the second decryption suppressing means 57b, only when the mutual ID and the unique ID are collated and corresponded to each other, the decryption of the encrypted content is permitted. The decryption suppressing method is the same as that of the embodiment 1.

The unique ID in the mutual ID recorded in the first recording device 19a and the unique ID 20a of the second recording device 19b correspond to each other, and therefore the second decryption suppressing means 57b permits the decryption (S1113).

In the second decrypting means 58b, the encrypted content C4 is decrypted by using the mutual encryption key K2 in the mutual ID, the copy once content C3 is recorded in the first recording device 19a (S1114).

The encrypted content C4 and the mutual ID recorded in the first recording device 19a are deleted (S1115).

### INDUSTRIAL APPLICABILITY

The technique improved in reliability such as a Move of the copy once content of the present invention is distributed by a digital terrestrial broadcasting, and is useful as the technique of normally moving the copy once content accumulated in the recording device such as a HDDD to other recording device, and in addition, can be applied to the purpose of use of a data backup function, and so forth.

1. A content data processing device in which a plurality of recording devices or recording media are connected, comprising:
a unique ID reading means for reading at least two unique IDs from said plurality of recording devices or recording media;
a mutual ID creating means for creating a mutual encryption key from said at least two unique IDs, creating a mutual ID, with said mutual encryption key and said at least two unique IDs as elements, and recording said mutual ID in any one of said plurality of recording devices or recording media; and
an original data suppressing means for encrypting data recorded in said recording devices or recording media by using said mutual encryption key included in said mutual ID, and recording the encrypted data in any one of said plurality of recording devices or recording media, and deleting original data or making it unreadable.

2. The content data processing device according to claim 1, comprising:
a reproduction suppressing means for determining whether or not read unique ID corresponds to at least two unique IDs in said mutual ID, when said unique ID reading means reads the unique ID from said recording devices or recording media in which said mutual ID and said encrypted data are recorded, and permitting a reproduction of said encrypted data when the read unique ID corresponds to either one of at least two unique IDs in said mutual ID, and suppressing the reproduction of said encrypted data when the read unique ID corresponds to neither of them.

3. The content data processing device according to claim 1, comprising:
a decryption suppressing means for determining whether or not read unique ID corresponds to either one of at least two unique IDs in said mutual ID, when said unique ID reading means reads the unique ID from said recording devices or recording media in which said mutual ID and said encrypted data are recorded, permitting a decryption of said encrypted data when the read unique ID corresponds to either one of at least two unique IDs in said mutual ID, decrypting said encrypted data by using said mutual encryption key in said mutual ID and recording it in said recording devices or recording media, and deleting said encrypted data and said mutual ID or making them unreadable, and suppressing the decryption when the read unique ID correspond to neither of them.

4. A recording/reproduction device having the content data processing device according to claim 1 and a plurality of recording devices or recording media.

5. A recording/reproduction device having the content data processing device according to claim 2, and a plurality of recording devices or recording media.

6. A recording/reproduction device having the content data processing device according to claim 3 and a plurality of recording devices or recording media.

7. A recording/reproduction system in which the content data processing device according to claim 1 and a plurality of devices having at least one recording device or recording medium are connected.

8. A recording/reproduction system in which the content data processing device according to claim 2 and a plurality of devices having at least one recording device or recording medium are connected.

9. A recording/reproduction system in which the content data processing device according to claim 3 and a plurality of devices having at least one recording device or recording medium are connected.

10. The content data processing device according to claim 1, comprising:
a copy suppressing means for determining whether or not read unique ID corresponds to either one of at least two unique IDs in said mutual ID, when said unique ID reading means reads the unique ID from said recording devices or recording media in which said mutual ID and said encrypted data are recorded, permitting said encrypted data to be copied to said recording devices or recording media when the read unique ID corresponds to either one of at least two unique IDs in said mutual ID, and suppressing the copy of said encrypted data to said recording device or recording media when the read unique ID corresponds to neither of them.

11. The content data processing device according to claim 2, comprising:
a copy suppressing means for determining whether or not read unique ID corresponds to either one of at least two unique IDs in said mutual ID, when said unique ID reading means reads the unique ID from said recording devices or recording media in which said mutual ID and said encrypted data are recorded, permitting said encrypted data to be copied to said recording devices or recording media when the read unique ID corresponds to either one of at least two unique IDs in said mutual ID, and suppressing copy of said encrypted data to said recording devices or recording media when the read unique ID corresponds to neither of them.

12. The content data processing device according to claim 3, comprising:
a copy suppressing means for determining whether or not read unique ID corresponds to either one of at least two unique IDs in said mutual ID, when said unique ID reading means reads the unique ID from said recording devices or recording media in which said mutual ID and said encrypted data are recorded, permitting said encrypted data to be copied to said recording devices or recording media when the read unique ID corresponds to either one of at least two unique IDs in said mutual ID, and suppressing the copy of said encrypted data to said recording devices or recording media when the read unique ID corresponds to neither of them.

13. A recording/reproduction device having the content data processing device according to claim 10 and a plurality of recording devices or recording media.

14. A recording/reproduction device having the content data processing device according to claim 11 and a plurality of recording devices or recording media.

15. A recording/reproduction device having the content data processing device according to claim 12 and a plurality of recording devices or recording media.

16. A recording/reproduction system in which the content data processing device according to claim 10 and a plurality of devices having at least one recording device or recording medium are connected.

17. A recording/reproduction system in which the content data processing device according to claim 11 and a plurality of devices having at least one recording device or recording medium are connected.

18. A recording/reproduction system in which the content data processing device according to claim 12 and a plurality of devices having at least one recording device or recording medium are connected.
